(19) United States
(12) Patent Application Publication
(10) Pub. No.: US 2003/0012381 A1
(43) Pub. Date: Jan. 16, 2003

(54) Analog signal scrambler for any phone, including cellular phones, employing a unique frame synchronization system

(75) Inventor: Eliahu Shichor, Haifa (IL)

Correspondence Address: OLIFF & BERRIDGE, PLC, P.O. BOX 19928, ALEXANDRIA, VA, 22320, US

(73) Assignee: Eliahu Shichor, Haifa (IL)

(21) Appl. No.: 10/152,573

(22) Filed: May 23, 2002

(30) Foreign Application Priority Data
Jun. 3, 2001 (IL) 143533

(51) Int. Cl. H04L 9/00

(52) U.S. Cl. 380/268

(57) ABSTRACT

A method for analog signal scrambling and unscrambling is provided for any type of phone, including cellular phones, by way of dividing the signal to disjoint frames, scrambling these frames at the analog-signal-transmission unit connected to the transmitting phone, and unscrambling and splicing the frames at the analog-signal-reception unit connected to the receiving phone, thereby recovering a continuous replica of the original analog signal

### FIELD OF THE INVENTION

This invention relates to a method for scrambling and unscrambling of a telephone analog signal using frame synchronization that applies to any phone, be it a cellular or a regular phone.

### BACKGROUND OF THE INVENTION

Speech scramblers have been known for a long time: they turn speech into a noise-like signal that can not be understood by a third party. The distortion of these noise-like signals that is caused by the speech compression-decompression systems used in certain phone systems make these scramblers unsuitable for cellular phones.

### SUMMARY OF THE INVENTION

There is provided a method for analog signal scrambling and unscrambling for any phone, including cellular phones:

1. Scrambling is performed by dividing the signal into specially designed disjoint frames and scrambling them at the transmitting phone.

2. Unscrambling is performed at the receiving phone by detecting these frames while maintaining frame synchronization, unscrambling the frames and rejoining them to get back a replica of the original analog signal.

The invention further includes a counterpart system to perform the specified method.

### BRIEF DESCRIPTION OF THE DRAWINGS

In order to understand the invention and to see how it may be implemented in practice, a preferred embodiment will now be described, by way of non-limiting example only, with reference to the accompanying drawings, in which signal values vs. time are shown using an arbitrary scale:

FIG. 1 illustrates an example of the original analog signal.

FIG. 2 is the block diagram of the analog signal transmission unit, where the signal is broken down into frames and these frames are transmitted in pseudo random order;

FIG. 3 illustrates the analog signal divided into disjoint frames showing frame boundaries;

FIG. 4 illustrates how accelerating the signal shown in FIG. 3 opens up a gap between frames with no signal in it;

FIG. 5 schematically illustrates a triangular piece slicing from the beginning of each frame, where this slice will be later used to fill up the said gap;

FIG. 6 schematically illustrates how the sliced triangular piece is moved and attached to the end of the previous frame to fill up the said gap to achieve signal continuity;

FIG. 7 illustrates the analog signal previously shown in FIG. 4 with the V-shaped frame boundary when the gap is now partially filled for signal continuity. This V-shaped frame boundary is later used for frame synchronization;

FIG. 8 is the block diagram of the analog signal reception unit where the scrambled analog signal is received, frame synchronization is performed and the frames are unscrambled and rejoined to get back a replica of the original signal;

FIG. 9 schematically illustrates the process of rejoining, herein referred to as “splicing”, of the frames of the signal shown schematically in FIG. 6. The V-shaped frame boundaries of neighboring frames match and disappear when the signal of the two frames is added up;

FIG. 10 illustrates how pieces of other shapes, not just triangular pieces, can be used for slicing and splicing of the analog signal frames. In this example, which is a blow-up of a figure similar to FIG. 9, a raised cosine function is used rather than a straight-line for slicing and splicing of the analog signal frames;

FIG. 11 illustrates the reconstructed analog signal after unscrambling, splicing the frames as was shown in FIG. 9 and signal deceleration. This reconstructed analog signal is a continuous replica of the input analog signal.

### DETAILED DESCRIPTION OF THE INVENTION

This invention provides a method and a system that turns analog signals such as speech into another analog signal that cannot be understood by a third party and provides a method of frame synchronization that is not degraded by, nor does it interfere with, the normal phone operation.

This invention describes a method and a system that scrambles an analog signal by dividing it up into specially designed disjoint frames. The transmitter then scrambles these frames and transmits them. The receiver, upon receiving these frames, detects the specially designed frame boundaries to maintain frame synchronization with the transmitting unit. This enables the receiver to unscramble these frames.

These frames and frame boundaries do not interfere with the normal operation of any telephone, be it a cellular or regular phone.

After unscrambling the frames, the frames are joined together by a process herein referred to as “splicing” where frame boundaries match when combined together and reconstruct a continuous replica of the original analog signal.

This scrambling method meets the following three requirements:

1. All frame synchronization information is included in the analog signal itself in the specially designed frame boundaries, so that there is no need for any other information for synchronization.

2. Frame boundaries are designed to match so that the synchronization information is completely removed from the analog signal after unscrambling and splicing the frames, and the listener does not hear any of it.

3. This frame synchronization method is such that synchronization is maintained when the analog signal goes through the compression-decompression system of any telephone channel, cellular or another.

Using this method, we can thus receive and synchronize on any analog signal transmitted by any phone, including cellular phones.

According to one embodiment, the system works as follows:

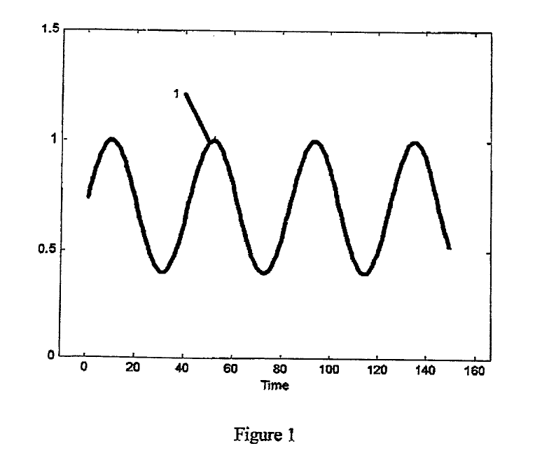

1. As shown in FIG. 1, the original analog signal (1) has an arbitrary waveform. Any analog signal passed through the phone can be scrambled. The waveform shown in FIG. 1 is used for illustration purpose only.

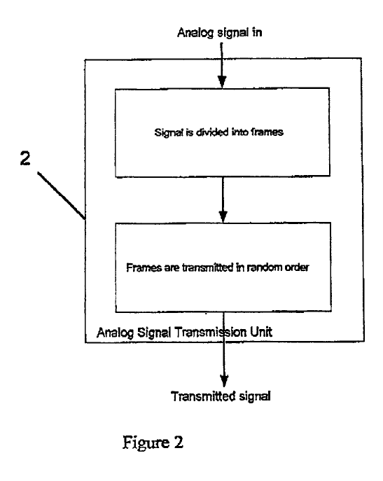

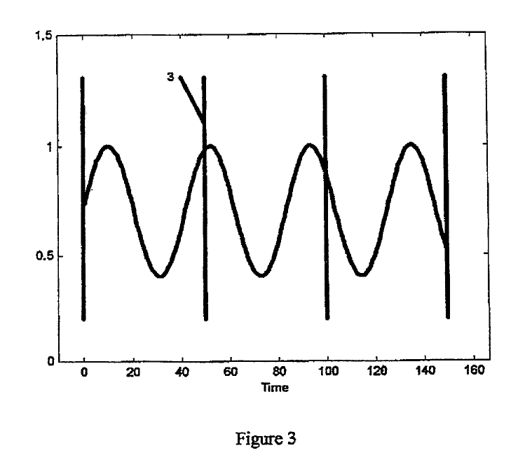

2. The analog signal enters the analog-signal-transmission unit (2), shown in FIG. 2. This unit divides the signal into disjoint frames. The analog signal with the frame boundary (3) is shown in FIG. 3.

3. The analog signal in each frame is slightly accelerated, i.e. each frame is played at a speed that is slightly faster than the original speed. This acceleration raises slightly the pitch of the analog signal. However, since the change of speed is by only a few percent, its effect on the pitch of the signal is almost unnoticeable. For example, raising the pitch by 6% is equivalent to going up by a half note on the musical scale. It is readily appreciated that 6% is only an example. This slight distortion is later corrected by the analog-signal-reception unit.

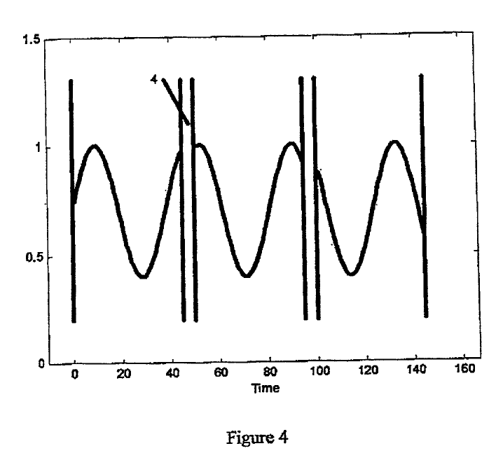

4. As each frame of the analog signal is accelerated, a gap with no signal in it (4) opens up at the end of each frame, as shown in FIG. 4.

5. The analog signal going through the telephone channel has to be continuous. To this end the gap (4) is filled up as follows:

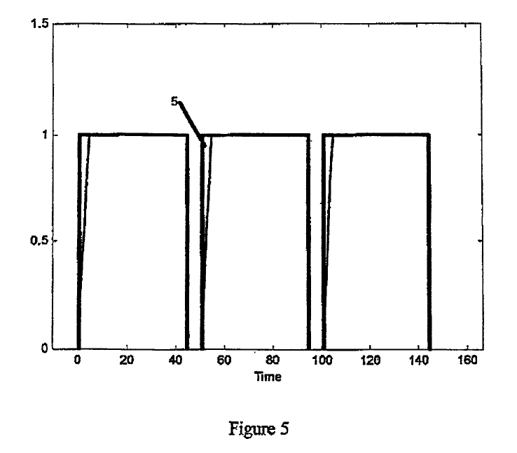

5.1. A small triangular piece (5) is sliced from the beginning of each frame of the signal, as shown schematically in FIG. 5.

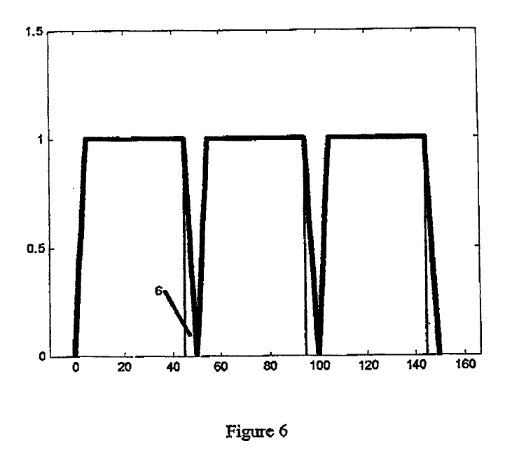

5.2. This triangular piece is now shifted in time and attached to the end of the signal of the previous frame. Said peace (6) is shown schematically in FIG. 6.

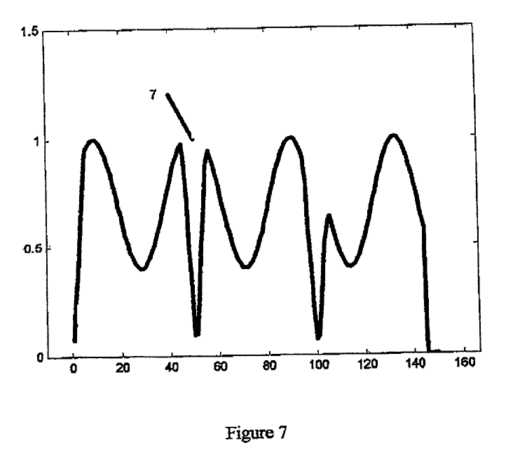

6. As is shown in FIG. 7, the new signal now has a typical V shape (7) at every frame boundary. This V shape will later be used by the analog-signal-reception unit to maintain frame synchronization.

7. The frames of this signal are now scrambled and transmitted by the phone.

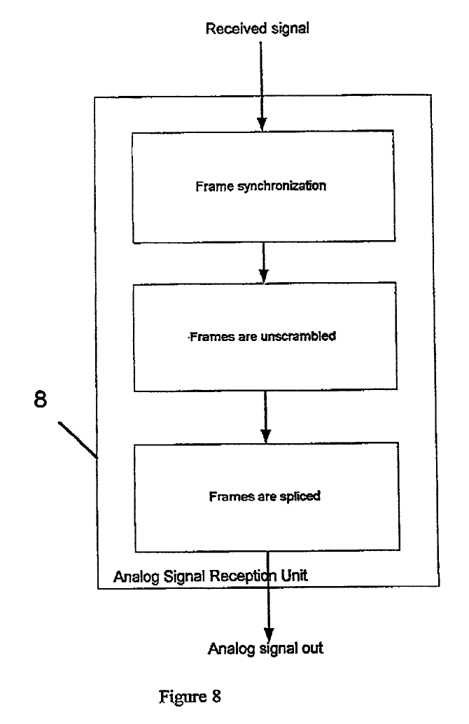

8. The analog-signal-reception unit (8) that is used for unscrambling the signal is shown in FIG. 8. This unit is connected to the other end of the telephone channel. This unit now searches the received scrambled signal for said typical V shaped frame-boundaries (7) and detects them. Frame-boundary-detection enables the analog-signal-reception unit to maintain frame synchronization as described in paragraph 6 above.

9. When frame synchronization is maintained, the analog-signal-reception unit unscrambles the frames.

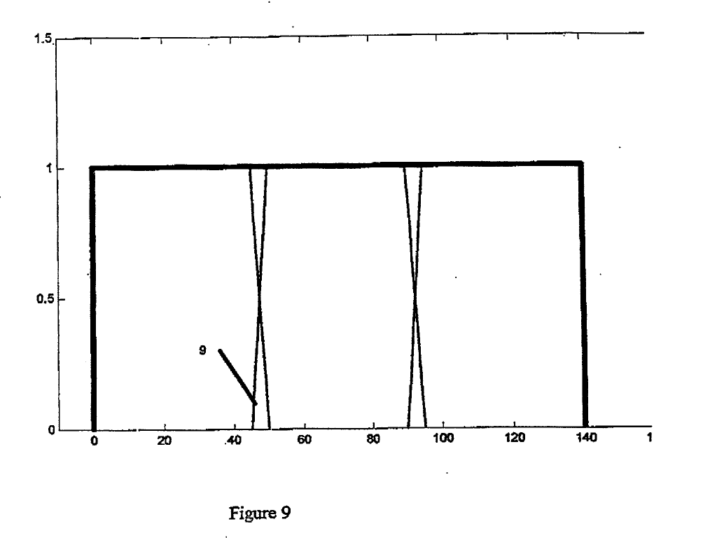

10. The analog-signal-reception unit then merges the frames by the splicing operation: moving the frames closer to one another and adding the signal values of these frames. This splicing process is shown schematically in FIG. 9: The two triangular pieces now match (9) and the splicing operation produces a continuous replica of the original analog signal with no frame boundaries.

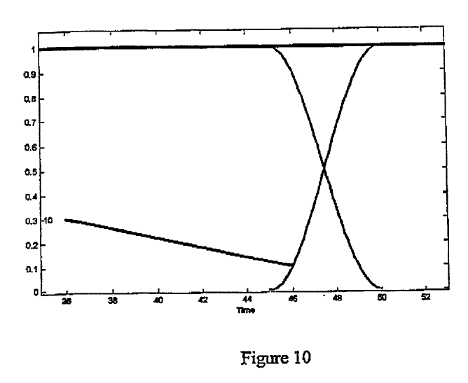

11. It should be understood that the slicing and splicing operation, described in paragraphs 5 to 10, can be performed with signal pieces of different shapes, other than just triangular pieces. By way of example, the signal in our system is also sliced using the raised cosine function. The reconstructed signal when using this raised cosine function (10) for slicing and splicing is shown in FIG. 10.

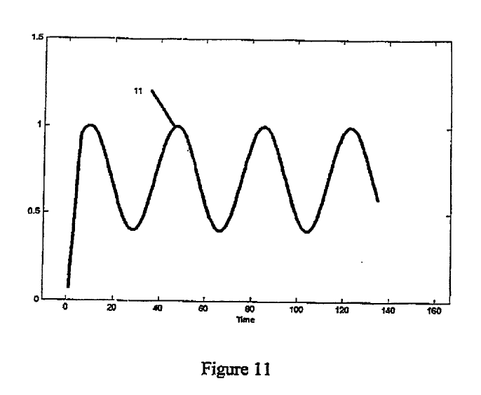

12. The reconstructed analog signal (11) is shown in FIG. 11. No frame boundaries can now be seen or heard.

13.After splicing the frames together the analog signal becomes shorter. This analog signal is now decelerated, or stretched in time, to regain its original pitch and time length.

14. Other means of analog signal scrambling, like frequency inversion and/or time inversion of the analog signal within each frame, can be added to this scrambling method and applied as well, as extra measures of security. These extra security measures can be added as long as the distortion that is caused by the phone compression-decompression system is small. In any case, frame synchronization is the basis for the operation of an extended system like this.

15. The whole system can be designed and built using two commercially available DSP chips, one at the analog-signal-transmission unit and one at the analog-signal-reception unit.

1: A method for analog signal scrambling and unscrambling is provided for any type of phone, including cellular phones, by way of dividing the signal to disjoint frames, scrambling these frames at the analog-signal-transmission unit connected to the transmitting phone, and unscrambling and splicing the frames at the analog-signal-reception unit connected to the receiving phone, thereby recovering a continuous replica of the original analog signal.

2: A method is provided according to claim 1 where upon dividing an analog signal at one end of a phone channel into disjoint frames with specially designed frame boundaries, provides an analog-signal-receiving unit at the receiving phone with means to detect and maintain frame synchronization. This frame synchronization method is not degraded by, nor does it interfere with, normal phone operation.

3: A method is provided for analog signal transmission for any phone, including cellular phones, by way of scrambling the signal. This is done by dividing the analog signal into disjoint frames, shaping frame boundaries to provide for frame synchronization and scrambling these frames.

4: A method is provided for analog signal reception by any type of phone, including cellular phones, by detecting said specially designed frame boundaries in the signal to maintain frame synchronization. When frame synchronization is maintained the method provides for unscrambling the disjoint frames, splicing these frames to a continuous replica of the original analog signal and correction of previous pitch change of the signal.
